(19) United States
(12) Patent Application Publication
(10) Pub. No.: US 2012/0057550 A1
(43) Pub. Date: Mar. 8, 2012

(54) Method, Apparatus, and System for Transmitting Packet Service Data

(75) Inventors: Yongxiang Zhao, Shanghai (CH); Yu Shao, Munich (DE); Shujuan Wang, Shenzhen (CN); Ming Li, Shenzhen (CN); Jiahong Wei, Shenzhen (CN); Wenyuan Yong, Shanghai (CN); Shengyi Qin, Shanghai (CN); Hua Qiu, Shanghai (CN); Yaowen Zhang, Shenzhen (CN); Wei Gu, Shenzhen (CN); Guangwei Wang, Shanghai (CN)

(73) Assignee: HUAWEI TECHNOLOGIES CO., LTD., Shenzhen (CN)

(21) Appl. No.: 13/290,674

(22) Filed: Nov. 7, 2011

Related U.S. Application Data
(63) Continuation of application No. PCT/CN2010/072433, filed on May 4, 2010.

(30) Foreign Application Priority Data
May 7, 2009 (CN) 200910136556.2

(51) Int. Cl. H04W 40/00; H04W 72/04

(52) U.S. Cl. 370/329; 370/328

(57) ABSTRACT

The present disclosure relates to the communications field and discloses a method, an apparatus, and a system for transmitting packet service data Packet service data is sent by a User Equipment (UE). It is determined whether the packet service data is Internet service data according to a pre-obtained Internet service offloading policy. If the packet service data is Internet service data, the packet service data is transmitted to a Public Data Network (PDN) via a Metropolitan Area Network (MAN) and an IP backbone. Embodiments of the present disclosure may be applied to wireless communication systems such as a WCDMA system.

This application is a continuation of International Application No. PCT/CN2010/072433, filed on May 4, 2010, which claims priority to Chinese Patent Application No. 200910136556.2, filed on May 7, 2009, both of which are hereby incorporated by reference in their entireties.

### TECHNICAL FIELD

The present disclosure relates to the field of communications, and in particular, to a method, an apparatus, and a system for transmitting packet service data.

### BACKGROUND

As shown in FIG. 1, in a Packet Switched (PS) network of a Wideband Code Division Multiplex Access (WCDMA) system, after a User Equipment (UE) accesses a NodeB, the NodeB transmits packet service data sent by the UE to a Radio Network Controller (RNC) via a mobile backhaul. The RNC converges the packet service data, and then transmits the packet service data to a Public Data Network (PDN) through the General Packet Radio Service (GPRS) Tunneling Protocol-User plane (GTPU) via a Serving GPRS Support Node (SGSN), an Internet Protocol (IP) backbone, and a Gateway GPRS Support Node (GGSN). A packet service server in the PDN provides services for the UE.

In the PS network shown in FIG. 1, a transmission path of packet service data is long and includes a lot of network devices. When the packet service data transmitted in the PS network, for example Internet service data, occupies a large network bandwidth, the operation and maintenance cost of the PS network is high.

### SUMMARY OF THE INVENTION

Embodiments of the present disclosure provide a method, an apparatus, and a system for transmitting packet service data, which can save the operation and maintenance cost of a PS network.

Embodiments of the present disclosure adopt the following technical solution.

A method for transmitting packet service data includes: receiving packet service data sent by a UE; determining whether the packet service data is Internet service data according to a pre-obtained Internet service offloading policy; and if the packet service data is Internet service data, transmitting the packet service data to a PDN via a Metropolitan Area Network (MAN) and an IP backbone.

An intelligent mobile edge gateway includes:

a first receiving unit, configured to receive packet service data sent by a UE;

a determining unit, configured to determine whether the packet service data received by the first receiving unit is Internet service data according to a pre-obtained Internet service offloading policy; and

a first sending unit, configured to transmit the packet service data to a PDN via an MAN and an IP backbone if the determining unit determines that the packet service data is Internet service data.

A communication system includes an intelligent mobile edge gateway, where:

the intelligent mobile edge gateway is configured to receive packet service data sent by a UE, determine whether the packet service data is Internet service data according to a pre-obtained Internet service offloading policy, and if the packet service data is Internet service data, transmit the packet service data to a PDN via an MAN and an IP backbone.

In the method, apparatus, and system for transmitting packet service data provided by the embodiments of the present disclosure, the intelligent mobile edge gateway is able to determine whether the packet service data sent by the UE is Internet service data according to the pre-obtained Internet service offloading policy, and if the packet service data is Internet service data, the intelligent mobile edge gateway transmits the packet service data via the MAN and the IP backbone, so as to save the operation and maintenance cost of the PS network, which solves the problem of a high PS network operation and maintenance cost in the prior art when packet service data occupying a large network bandwidth (for example the Internet service data) is transmitted because all packet service data sent by the UE needs to be transmitted via the mobile backhaul, RNC, SGSN, IP backbone, and GGSN.

### BRIEF DESCRIPTION OF THE DRAWINGS

FIG. 1 is a schematic architecture diagram of a PS network of a WCDMA system in a prior art;

FIG. 2 is a flow chart of a method for transmitting packet service data according to an embodiment of the present disclosure;

FIG. 3 is a schematic architecture diagram of a network where the method for transmitting packet service data according to another embodiment of the present disclosure is applied;

FIG. 4 is a flow chart of a method for transmitting packet service data according to another embodiment of the present disclosure;

FIG. 5 is a schematic architecture diagram of a network where the method for transmitting packet service data according to still another embodiment of the present disclosure is applied;

FIG. 6 is a first schematic structure diagram of an intelligent mobile edge gateway according to an embodiment of the present disclosure; and

FIG. 7 is a second schematic structure diagram of an intelligent mobile edge gateway according to an embodiment of the present disclosure.

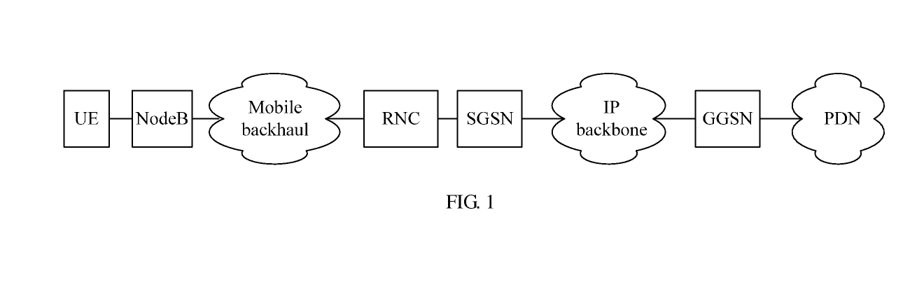

### DETAILED DESCRIPTION OF ILLUSTRATIVE EMBODIMENTS

To resolve the high operation and maintenance cost of a PS network, embodiments of the present disclosure provide a method, an apparatus, and a system for transmitting packet service data.

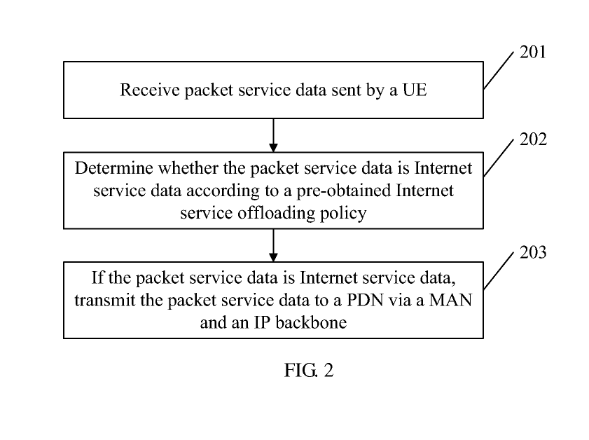

As shown in FIG. 2, an embodiment of the present disclosure provides a method for transmitting packet service data, where the method includes the following steps:

Step 201: Receive packet service data sent by a UE.

Step 202: Determine whether the packet service data is Internet service data according to a pre-obtained Internet service offloading policy.

Step 203: If the packet service data is Internet service data, transmit the packet service data to a PDN via an MAN and an IP backbone.

The method for transmitting packet service data in the embodiment of the present disclosure can transmit Internet service data occupying a large network bandwidth in packet service data via an MAN and an IP backbone so as to save the operation and maintenance cost of the PS network, which solves the problem of a high PS network operation and maintenance cost in the prior art when packet service data occupying the large network bandwidth (for example the Internet service data) is transmitted because all packet service data needs to be transmitted via a mobile backhaul, an RNC, an SGSN, the IP backbone, and a GGSN.

To help persons skilled in the art better understand the technical solution provided by the embodiments of the present disclosure, the method for transmitting packet service data is described in detail in the following through specific embodiments of the present disclosure.

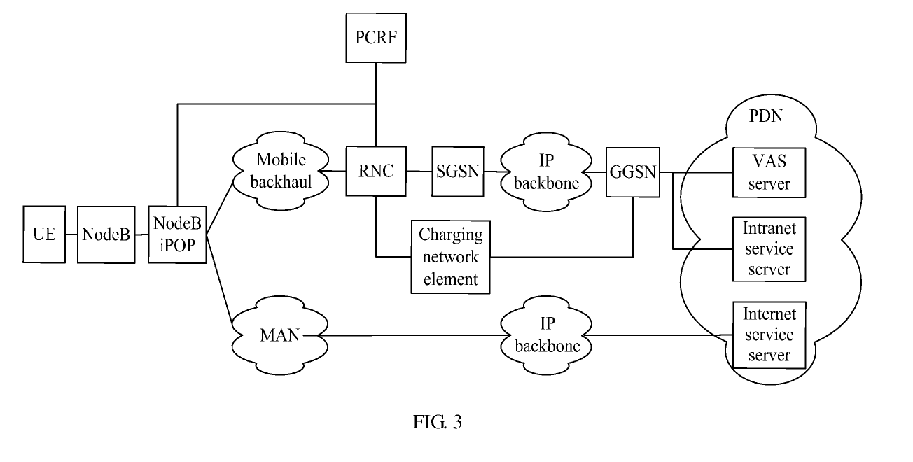

A method for transmitting packet service data according to another embodiment of the present disclosure may be applied to the network architecture shown in FIG. 3. As shown in FIG. 3, a UE initially accesses a NodeB and an intelligent mobile edge gateway (for example NodeB intelligent Point of Presence (NodeB iPOP)) may transmit packet service data sent by the UE to a PDN via two paths. One path is via an MAN and an IP backbone, and the other path is via a mobile backhaul, an RNC, an SGSN, an IP backbone, and a GGSN.

In this embodiment, the RNC is a home RNC, or host RNC, of the NodeB iPOP; the NodeB iPOP is operated and managed as a remote service unit of the RNC and has such functions as terminating an Iub user plane of Internet service data, using a deep packet inspection (DPI) technology to identify an Internet service to offload, allocating a mobile IP Care-of Address (CoA) to a UE, and MAN access.

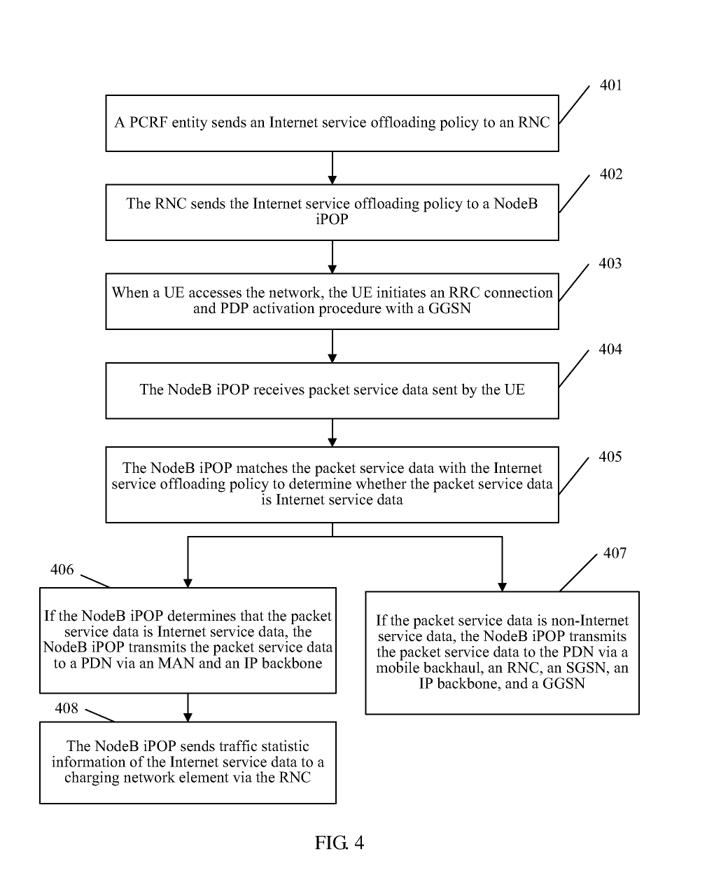

As shown in FIG. 4, in the network architecture shown in FIG. 3, a procedure for transmitting packet service data sent by a UE by using the method for transmitting packet service data in the embodiment of the present disclosure includes the following steps:

Step 401: A Policy and Charging Rules Function (PCRF) entity sends an Internet service offloading policy to the RNC.

In this embodiment, because the Internet service offloading policy is used to identify whether the packet service data sent by the UE is Internet service data, the PCRF may send the Internet service offloading policy to the RNC via a Gx interface.

The Internet service offloading policy may include many types of information.

For example, the Internet service offloading policy may include: IP addresses of more than one Internet service server (for example IP addresses of Wireless Application Protocol (WAP) service servers) and information indicating that packet service data destined for the IP addresses of the Internet service servers is Internet service data; or IP addresses of more than one non-Internet service server (such as IP addresses of value-added service (VAS) servers) and information indicating that packet service data destined for IP addresses other than the IP addresses of the non-Internet service servers is Internet service data; or IP addresses of more than one non-Internet service server and information indicating that packet service data destined for the IP addresses of the non-Internet service servers is non-Internet service data.

For another example, the Internet service offloading policy may include: more than one Internet service type (such as WAP service) and information indicating that packet service data of the Internet service types is Internet service data; or more than one non-Internet service type and information indicating that packet service data of service types other than the non-Internet service types is Internet service data; or more than one non-Internet service type and information indicating that packet service data of the non-Internet service types is non-Internet service data.

Definitely, the Internet service offloading policy may also include other information.

The specific setting depends on actual needs and is not enumerated herein.

Step 402: The RNC sends the Internet service offloading policy to a NodeB iPOP.

In this embodiment, for example, the RNC may send the Internet service offloading policy to the NodeB iPOP through an internal interface.

Step 403: When the UE accesses the network, the UE initiates a Radio Resource Control (RRC) connection and a Packet Data Protocol (PDP) activation procedure with the GGSN.

Step 404: The NodeB iPOP receives packet service data sent by the UE.

Step 405: The NodeB iPOP matches the packet service data received in step 404 with the Internet service offloading policy obtained in step 402 to determine whether the packet service data is Internet service data.

In this embodiment, the NodeB iPOP may use a DPI technology to determine whether the packet service data is Internet service data according to the Internet service offloading policy.

For example, if the Internet service offloading policy includes IP addresses of more than one Internet service server and information indicating that packet service data destined for the IP addresses of the Internet service servers is Internet service data, or IP addresses of more than one non-Internet service server and information indicating that packet service data destined for IP addresses other than the IP addresses of the non-Internet service servers is Internet service data, or IP addresses of more than one non-Internet service server and information indicating that packet service data destined for the IP addresses of the non-Internet service servers is non-Internet service data, the NodeB iPOP may use DPI to extract a destination address from the packet service data received in step 404 and match the destination address with the IP addresses of the more than one Internet service server or non-Internet service server in the Internet service offloading policy. If the destination address matches the IP addresses of the Internet service servers (the destination address is the same as one of the IP addresses of the more than one Internet service server), the packet service data is Internet service data, and if the destination address does not match the IP addresses of the Internet service servers, the packet service data is other packet service data; or if the destination address does not match the IP addresses of the non-Internet service servers (the destination address is different from any of the IP addresses of the non-Internet service servers), the packet service data is Internet service data, and if the destination address matches the IP addresses of the non-Internet service servers, the packet service data is other packet service data.

For another example, if the Internet service offloading policy includes more than one Internet service type and information indicating that packet service data of the Internet service types is Internet service data, or more than one non-Internet service type and information indicating that packet service data of service types other than the non-Internet service types is Internet service data, or more than one non-Internet service type and information indicating that packet service data of the non-Internet service types is non-Internet service data, the NodeB iPOP may use the DPI technology to extract service type information from the packet service data received in step 404 and match the service type with the Internet service type or non-Internet service type. If the service type of the packet service data matches the Internet service types (the service type of the packet service data is the same as one of the more than one Internet service type), the packet service data is Internet service data, and if the service type of the packet service data does not match the Internet service types, the packet service data is other packet service data; or if the service type of the packet service data does not match the non-Internet service types (the service type of the packet service data is different from any of the non-Internet service types), the packet service data is Internet service data, and if the service type of the packet service data matches the non-Internet service types, the packet service data is other packet service data.

Step 406: If the NodeB iPOP determines that the packet service data is Internet service data, the NodeB iPOP transmits the packet service data to the PDN via the MAN and the IP backbone.

In this embodiment, when the packet service data is Internet service data, the NodeB iPOP may terminate the Tub user plane of the Internet service and transmit the Internet service data to a router of the MAN. The router will continue to transmit the data.

Step 407: If the NodeB iPOP determines that the packet service data is packet service data other than Internet service data (such as intranet service data or VAS service data), the NodeB iPOP transmits the packet service data to the PDN via the mobile backhaul, RNC, SGSN, IP backbone, and GGSN.

Optionally, because the technical solution provided by the embodiment of the present disclosure transmits Internet service data via the MAN and the IP backbone, to enable charging for the Internet service data, after step 406, the procedure may further include the following step.

Step 408: The NodeB iPOP sends traffic statistic information of the Internet service data to a charging network element via the RNC and the charging network element charges for the Internet service data.

With the method for transmitting packet service data according to the embodiment of the present disclosure, the NodeB iPOP can transmit Internet service data occupying a large network bandwidth in packet data service via the MAN and the IP backbone so as to save the operation and maintenance cost of the PS network, which solves the problem of a high PS network operation and maintenance cost in the prior art when packet service data occupying the large network bandwidth (for example the Internet service data) is transmitted because all packet service data needs to be transmitted via the mobile backhaul, RNC, SGSN, IP backbone, and GGSN. Because the NodeB iPOP uses the DPI technology to determine whether the packet service data is Internet service data according to a pre-obtained Internet service offloading policy, the technical solution provided by the embodiment of the present disclosure does not change the original intercommunication architecture among network devices in the PS network and does not affect the existing PS network structure.

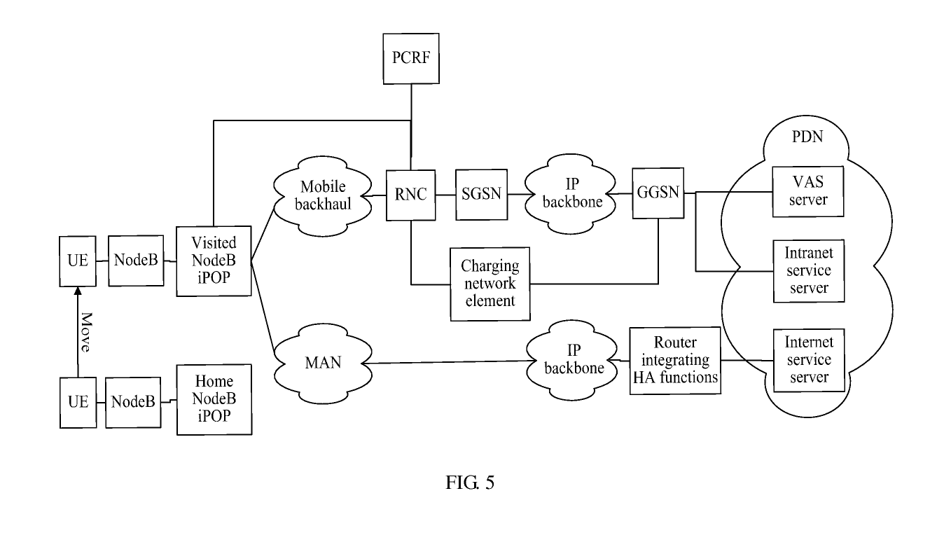

A still another embodiment of the present disclosure provides a method for transmitting packet service data, where the method may be applied to the network architecture shown in FIG. 5. As shown in FIG. 5, a UE moves from a home NodeB iPOP to a visited NodeB iPOP. The visited NodeB iPOP may transmit packet service data sent by the UE to a PDN via two paths. One path is via an MAN, an IP backbone, and a router integrating mobile IP Home Agent (HA) functions; and the other path is via a mobile backhaul, an RNC, an SGSN, an IP backbone, and a GGSN, where the RNC is the home RNC, or Host RNC, of the visited NodeB iPOP.

The procedure of the method for transmitting packet service data according to this embodiment is substantially the same as the procedure of the method for transmitting packet service data according to the embodiment of the present disclosure shown in FIG. 4. The difference is that, before the visited NodeB iPOP receives the packet service data sent by the UE, the method further includes the following step: the visited NodeB iPOP allocates a mobile IP CoA to the UE and sends the CoA to the router integrating HA functions via the MAN and the IP backbone, and the router integrating HA functions establishes a binding relationship between the CoA and the mobile IP Home Address (HoA) of the UE, so that the UE can communicate with a service server in the PDN via the NodeB iPOP.

In this embodiment, if the packet service data sent by the UE is Internet service data, the visited NodeB iPOP may transmit the Internet service data to the PDN via the MAN, IP backbone, and the router integrating HA functions.

With the method for transmitting packet service data according to the embodiment of the present disclosure, the visited NodeB iPOP can allocate the CoA to the UE and send the CoA to the router integrating HA functions, and the router integrating HA functions establishes the binding relationship between the CoA and the HoA of the UE, so that when the packet service data sent by the UE is Internet service data, the UE can transmit the Internet service data to the PDN through the visited NodeB iPOP via the MAN, the IP backbone, and the router integrating HA functions, which solves the mobility problem of the UE. Because the visited NodeB iPOP transmits Internet service data occupying a large network bandwidth in packet service data via the MAN, IP backbone, and router integrating HA functions, the operation and maintenance cost of the PS network is saved, which solves the problem of a high PS network operation and maintenance cost in the prior art when packet service data occupying the large network bandwidth (for example the Internet service data) is transmitted because all packet service data needs to be transmitted via the mobile backhaul, RNC, SGSN, IP backbone, and GGSN.

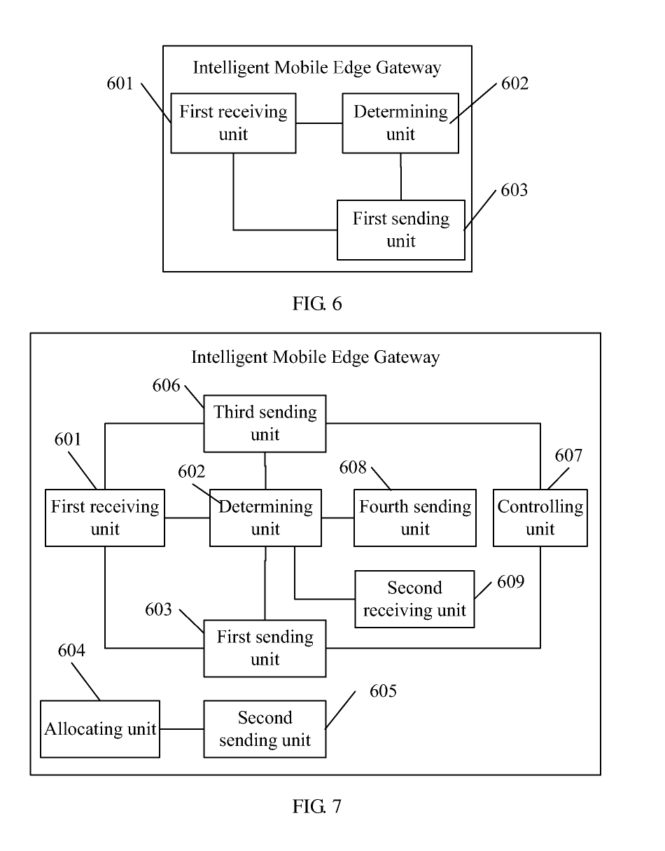

As shown in FIG. 6, an embodiment of the present disclosure provides an intelligent mobile edge gateway, including:

a first receiving unit 601, configured to receive packet service data sent by a UE;

a determining unit 602, configured to determine whether the packet service data received by the first receiving unit 601 is Internet service data according to a pre-obtained Internet service offloading policy; and

a first sending unit 603, configured to transmit the packet service data to a PDN via an MAN and an IP backbone if the determining unit 602 determines that the packet service data is Internet service data.

Further, the determining unit 602 is configured to use a DPI technology to determine whether the packet service data received by the first receiving unit 601 is Internet service data according to the pre-obtained Internet service offloading policy.

As shown in FIG. 7, the intelligent mobile edge gateway may further include:

an allocating unit 604, configured to allocate a mobile IP CoA to the UE; and

a second sending unit 605, configured to send the mobile IP CoA allocated by the allocating unit 604 to a router integrating mobile IP HA functions via the MAN and the IP backbone.

The first sending unit 603 may be further configured to transmit the packet service data to a PDN via the MAN, the IP backbone, and the router integrating HA functions if the determining unit 602 determines that the packet service data is Internet service data.

As shown in FIG. 7, the intelligent mobile edge gateway may further include:

a third sending unit 606, configured to transmit the packet service data to the PDN via a mobile backhaul, an RNC, an SGSN, an IP backbone, and a GGSN if the determining unit 602 determines that the packet service data is packet service data other than Internet service data.

As shown in FIG. 7, the intelligent mobile edge gateway may further include:

a controlling unit 607, configured to: when the determining unit 602 determines that the packet service data is Internet service data, terminate an Iub user plane of the Internet service data, stop the third sending unit 606 from sending the Internet service data, and start the first sending unit 603 to send the Internet service data.

As shown in FIG. 7, the intelligent mobile edge gateway may further include:

a fourth sending unit 608, configured to send traffic statistic information of the Internet service data determined by the determining unit 602 to a Charging Gateway (CG) via the

RNC.

As shown in FIG. 7, the intelligent mobile edge gateway may further include:

a second receiving unit 609, configured to receive the Internet service offloading policy sent by a PCRF via the RNC, so that the determining unit 602 determines whether the packet service data received by the first receiving unit 601 is Internet service data according to the Internet service offloading policy.

The process of applying the apparatus provided by the embodiment of the present disclosure to transmit packet service data is similar to the method embodiments of the present disclosure and is not described here.

The intelligent mobile edge gateway provided by the embodiment of the present disclosure is able to determine whether the packet service data sent by the UE is Internet service data according to the pre-obtained Internet service offloading policy, and if the packet service data is Internet service data, the NodeB iPOP transmits the packet service data via the MAN and the IP backbone, so as to save the operation and maintenance cost of the PS network, which solves the problem of a high PS network operation and maintenance cost in the prior art when packet service data occupying a large network bandwidth (for example the Internet service data) is transmitted because all packet service data sent by the UE needs to be transmitted via the mobile backhaul, RNC, SGSN, IP backbone, and GGSN.

An embodiment of the present disclosure also provides a communication system, including an intelligent mobile edge gateway.

The intelligent mobile edge gateway is configured to receive packet service data sent by a UE, determine whether the packet service data is Internet service data according to a pre-obtained Internet service offloading policy, and if the packet service data is Internet service data, transmit the packet service data to a PDN via an MAN and an IP backbone.

Further, the intelligent mobile edge gateway is further configured to transmit the packet service data to the PDN via a mobile backhaul, an RNC, an SGSN, an IP backbone, and a GGSN if the packet service data is packet service data other than the Internet service data.

Further, if the intelligent mobile edge gateway is a visited intelligent mobile edge gateway of the UE, the communication system may further include a router integrating mobile IP HA functions.

The router integrating mobile IP HA functions is configured to receive a mobile IP CoA of the UE sent by the intelligent mobile edge gateway and establish a binding relationship between the mobile IP CoA and the mobile IP HoA of the UE.

The intelligent mobile edge gateway is further configured to allocate the mobile IP CoA to the UE and send the mobile IP CoA to the router integrating mobile IP HA functions via the MAN and the IP backbone.

The process of applying the system provided by the embodiment of the present disclosure to transmit packet service data is similar to the method embodiments of the present disclosure and is not described here.

With the communication system provided by the embodiment of the present disclosure, the intelligent mobile edge gateway is able to determine whether the packet service data sent by the UE is Internet service data according to the pre-obtained Internet service offloading policy, and if the packet service data is Internet service data, the NodeB iPOP transmits the packet service data via the MAN and the IP backbone, so as to save the operation and maintenance cost of the PS network, which solves the problem of a high PS network operation and maintenance cost in the prior art when packet service data occupying a large network bandwidth (for example the Internet service data) is transmitted because all packet service data sent by the UE needs to be transmitted via the mobile backhaul, RNC, SGSN, IP backbone, and GGSN. When the intelligent mobile edge gateway is the visited intelligent mobile edge gateway of the UE, the intelligent mobile edge gateway can allocate the mobile IP CoA to the UE and send the CoA to the router integrating mobile IP HA functions, and the router establishes a binding relationship between the CoA and the HoA of the UE, so that when the packet service data sent by the UE is Internet service data, the visited intelligent mobile edge gateway can transmit the Internet service data to the PDN via an MAN, an IP backbone, and the router integrating HA functions, which solves the mobility problem of the UE.

The method, apparatus, and system for transmitting packet service data according to the embodiments of the present disclosure can be applied to wireless communication systems such as a WCDMA system.

Those skilled in the art understand that all or part of the steps in the methods provided by the foregoing embodiments of the present disclosure may be implemented by hardware under the instruction of a program. The program may be stored in a computer readable storage medium, such as a Read Only Memory (ROM), a Random Access Memory (RAM), a magnetic disk, or a Compact Disk-Read Only Memory (CD-ROM).

Detailed in the foregoing are only exemplary embodiments of the present disclosure, but the scope of the present disclosure is not limited thereto. Any modification or substitution readily conceivable by those skilled in the art within the scope of the technology disclosed by the present disclosure shall fall within the scope of the present disclosure. Therefore, the scope of the present disclosure is subject to the appended claims.

1. A method for transmitting packet service data, the method comprising:
receiving packet service data sent by a user equipment (UE);
determining whether the packet service data is Internet service data according to a pre-obtained Internet service offloading policy; and
if the packet service data is Internet service data, transmitting the packet service data to a public data network (PDN) via a metropolitan area network (MAN) and an internet protocol (IP) backbone.

2. The method according to claim 1, wherein determining whether the packet service data is Internet service data comprises:
using a deep packet inspection (DPI) technology to determine whether the packet service data is Internet service data according to the pre-obtained Internet service offloading policy.

3. The method according to claim 1, before the receiving packet service data sent by the UE, the method further comprises:
allocating a mobile IP Care-of Address (CoA) to the UE; and
sending the mobile IP CoA to a router integrating mobile IP home agent (HA) functions via the MAN and the IP backbone.

4. The method according to claim 3, wherein transmitting the packet service data to the PDN via the MAN and the IP backbone comprises:
transmitting the packet service data to the PDN via the MAN, the IP backbone, and the router integrating mobile IP HA functions.

5. The method according to claim 1, further comprising:
if the packet service data is non-Internet service data, transmitting the packet service data to the PDN via a mobile backhaul, a radio network controller (RNC), a serving general packet radio service (GPRS) support node (SGSN), an IP backbone, and a gateway GPRS support Node (GGSN).

6. The method according to claim 1, further comprising:
sending traffic statistic information of the internet service data to a charging gateway (CG) via an RNC.

7. The method according to claim 1, further comprising:
receiving the Internet service offloading policy sent by a policy and charging rules function (PCRF) via an RNC.

8. An intelligent mobile edge gateway, comprising:
a first receiving unit, configured to receive packet service data sent by a user equipment (UE);
a determining unit, configured to determine whether the packet service data received by the first receiving unit is Internet service data according to a pre-obtained Internet service offloading policy; and
a first sending unit, configured to transmit the packet service data to a public data network (PDN) via a metropolitan area network (MAN) and an internet protocol (IP) backbone if the determining unit determines that the packet service data is Internet service data.

9. The intelligent mobile edge gateway according to claim 8, wherein the determining unit is further configured to use a deep packet inspection (DPI) technology to determine whether the packet service data received by the first receiving unit is internet service data according to the pre-obtained Internet service offloading policy.

10. The intelligent mobile edge gateway according to claim 8, further comprising:
an allocating unit, configured to allocate a mobile IP Care-of Address (CoA) to the UE; and
a second sending unit, configured to send the mobile IP CoA allocated by the allocating unit to a router integrating mobile IP home agent (HA) functions via the MAN and the IP backbone, wherein:
the first sending unit is further configured to transmit the packet service data to the PDN via the MAN, the IP backbone, and the router integrating mobile IP HA functions if the determining unit determines that the packet service data is Internet service data.

11. The intelligent mobile edge gateway according to claim 8, further comprising:
a third sending unit, configured to transmit the packet service data to the PDN via a mobile backhaul, a radio network controller (RNC), a serving general packet radio service (GPRS) support node (SGSN), an IP backbone, and a gateway GPRS support node (GGSN) if the determining unit determines that the packet service data is non-Internet service data.

12. The intelligent mobile edge gateway according to claim 8, further comprising:
a controlling unit, configured to terminate an Iub user plane of the Internet service data when the determining unit determines that the packet service data is Internet service data.

13. The intelligent mobile edge gateway according to claim 8, further comprising:
a fourth sending unit, configured to send traffic statistic information of the Internet service data determined by the determining unit to a charging gateway (CG) via an RNC.

14. The intelligent mobile edge gateway according to claim 8, further comprising:
a second receiving unit, configured to receive the Internet service offloading policy sent by a policy and charging rules function (PCRF) via an RNC.

15. The intelligent mobile edge gateway according to claim 8, wherein the intelligent mobile edge gateway is located between a NodeB and an RNC.

16. A communication system, comprising an intelligent mobile edge gateway, wherein:
the intelligent mobile edge gateway is configured to receive packet service data sent by a user equipment (UE), to determine whether the packet service data is Internet service data according to a pre-obtained Internet service offloading policy, and, if the packet service data is Internet service data, to transmit the packet service data to a public data network (PDN) via a metropolitan area network (MAN) and an internet protocol (IP) backbone.

17. The communication system according to claim 16, wherein the intelligent mobile edge gateway is a visited intelligent mobile edge gateway of the UE, the communication system further comprising a router integrating mobile IP home agent (HA) functions, wherein
the router integrating mobile IP HA functions is configured to receive a mobile IP Care-of Address (CoA) of the UE sent by the intelligent mobile edge gateway and to establish a binding relationship between the mobile IP CoA and a mobile IP home address (HoA) of the UE; and
the intelligent mobile edge gateway is further configured to allocate the mobile IP CoA to the UE, to send the mobile IP CoA to the router integrating mobile IP HA functions via the MAN and the IP backbone, and, if the packet service data is Internet service data, to transmit the packet service data to the PDN via the MAN, the IP backbone, and the router integrating mobile IP HA functions.

18. The communication system according to claim 16, wherein, the intelligent mobile edge gateway is further configured to transmit the packet service data to the PDN via a mobile backhaul, a radio network controller (RNC), a serving general packet radio service (GPRS) support node (SGSN), the IP backbone, and a gateway GPRS support node (GGSN) when the packet service data is non-Internet service data.

19. The communication system according to claim 16, further comprising a NodeB and a radio network controller (RNC), wherein the intelligent mobile edge gateway is located between the NodeB and the RNC.

20. The communication system according to claim 16, further comprising:
a mobile backhaul;
a radio network controller;
a serving general packet radio service support node; and
a gateway GPRS support node;
wherein, the intelligent mobile edge gateway is further configured to transmit the packet service data to the PDN via the mobile backhaul, the radio network controller, the serving general packet radio service support node, the IP backbone, and the gateway GPRS support node when the packet service data is non-Internet service data.
